(19) United States
(12) Patent Application Publication
(10) Pub. No.: US 2024/0086797 A1
(43) Pub. Date: Mar. 14, 2024

(54) AI-BASED SYSTEM AND METHOD FOR SOFTWARE COMPLIANCE

(71) Applicant: Jeremy Miller, Indianapolis, IN (US)

(72) Inventor: Jeremy Miller, Indianapolis, IN (US)

(21) Appl. No.: 17/941,843

(22) Filed: Sep. 9, 2022

(51) Int. Cl. G06Q 10/06

(52) U.S. Cl. CPC G06Q 10/063118; G06Q 10/06398

(57) ABSTRACT

In some embodiments a server having one or more processors and one or more non-transitory computer readable media storing instructions executable by one or more processors to perform operations, the server determines based on aggregated data, a plurality of metrics associated with an employee, and also determines a training status of an employee, and predicts by one or more artificial intelligence modules executed on the server an optimal training trajectory and the outcome of a compliance audit cycle, the server sends by the one more processors assignments and milestones associated with the optimal training trajectory to the employee, and to the employees' manager.

### BACKGROUND

### Field of the Invention

The field of software development is constantly evolving especially in regards to AI and software enhanced by AI-assisted software packages. Concurrently, as software and AI enhanced software evolves in complexity, the standards for compliance and compliance audits must also evolve to prepare the personnel operating the systems in order to maintain the security, proper operation and procedures related to the systems. The current disclosure relates to the field of AI assisted user training, apprenticeship, audits in software use, operation, and regulatory compliance.

### Description of the Related Art

The following disclosure relates generally to the field of AI-based cybersecurity standards for compliance and the requirements of cybersecurity audits.

### SUMMARY

The following novel technology relates to an AI based software technology that guides an apprentice through complex training on compliance protocols, the system and method performs a compliance audit to determine whether an organization will successfully pass a compliance audit is set forth, in the claims below, and the following is not in any way to limit, define or otherwise establish the scope of legal protection.

The field of cybersecurity is evolving at a fast pace. As the field evolves, so do the standards that organizations must adhere to in order to remain compliant. Organizations that face this problem have a limited number of solutions. One solution is to hire an instructor to provide on-site, on the job training. Another solution is to send an employee off-site to attend training at a facility. Since each student is unique in their training education and experience it is impossible for an instructor to determine the most optimal solution for training for each student. Neither solution is optimal as on-site on the job training is prohibitively expensive, can only be provided to a limited number of students at a time and the results of the training are difficult to assess because they take place over an extended period of time. Additionally, off site training sends the employee away from the organization, lost work time puts the organization at risk of low staffing and an additional expense of paying for this training. The disclosed technology provides a system and a method of providing an AI-based guide for training employee on compliance protocols for compliance audits.

Further objects, embodiments, forms, benefits, aspects, features and advantages of the described technology may be obtained from the description, drawings, and claims provided herein.

### BRIEF DESCRIPTION OF THE DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1. Illustrates one embodiment of an AI-based compliance training software comprising an AI instruction module and an AI audit/evaluate module, where both modules are in communication with an employee, a manager, a client and a server(s).

FIG. 2. Illustrates one embodiment of an AI instruction module where the module communicates with a server(s), retrieves data from server(s) and and communicates INS assignments, an INS milestones and generates INS progress tracking and communicates a manager INS report, a client INS report, and an employee INS report.

FIG. 3. Illustrates one embodiment of the AI audit/evaluate module where the module predicts the outcome of an audit based on information retrieved from server(s) policy training check, software compliance check, employee compliance check of an organization.

### DETAILED DESCRIPTION

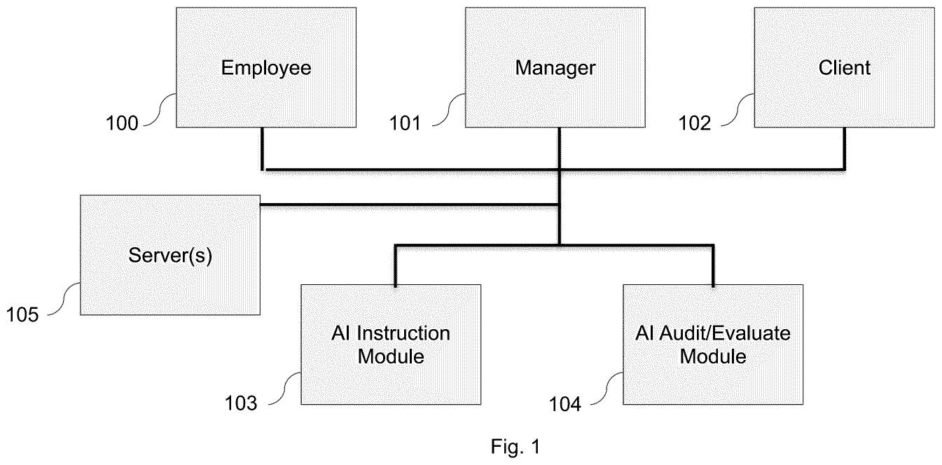

For the purposes of promoting an understanding of the principles of the described technology and presenting its currently understood best mode of operation, reference will now be made to the embodiments illustrated in the drawings and specific language will be used to describe the same. It will nevertheless be understood that no limitation of the scope of the described technology is thereby intended, with such alterations and further modifications in the illustrated device and such further applications of the principles of the described technology as illustrated therein being contemplated as would normally occur to one skilled in the art to which the described technology relates. Detailed reference will be made to one or more embodiments of the disclosure which are described in FIGS. 1 through 3.

The field of cybersecurity standards and protocols for compliance and audit is complex. NIST 800-171, CMMC, ISO 27001, HIPPA, GDPR/CCPA are some of the current compliance standards that organizations must comply with in order to meet regulatory requirements. Organizations currently have very few options in terms of services and training paradigms to meet these standards. As the number of compliance standards grows more complex, even seasoned professionals have difficulty understanding new requirements for each employee position.

A cybersecurity analyst will be required to fulfill many duties for their position. They will assist in developing security protocols and policies, and assist in enforcing company compliance with network security policies and protocols. There are hundreds of different protocols from many different organizations, each employee must complete different requirements, and many of the requirements are overlapping, meaning, at times the employee often completes a plurality of similar protocols from different organizations where only one protocol was required. The technical challenge here is identifying the training status of an employee, and predicting an optimal training trajectory based on a plurality of metrics and aggregated data on the employee. Examples of metrics include but are not limited to educational background, relevant experience, a job function specific exam, and relevant certifications. A further technical challenge this disclosure solves is eliminating duplicate learning efforts by determining which protocols are job specific, and identifying overlapping protocols.

Protocol training compliance is inexplicably linked to the outcome of a compliance audit. One technical challenge is determining whether employees have completed the correct compliance protocols for their position. Organizations face a technical challenge predicting the outcome of an audit cycle. Certain organizations are under obligations to undergo a compliance audit check by a 3rd party organization. The audits can be very complex, involve most, if not all of the employees of the organization, and can be very costly.

There are hundreds of protocols, many of them are overlapping and it is difficult to determine which protocols are necessary for each employee. The current disclosure describes an AI audit/evaluate module that predicts the outcome of a plurality of compliance audit metrics. The aforementioned embodiments are not intended to limit the scope of metrics for use in the predictions.

FIG. 1 illustrates one configuration of the current disclosure. Three different types of users, the employee 100, the manager 101, and the client 102 will interact with the AI instruction module 103 and the AI audit/evaluate module 104 and the server(s) 105.

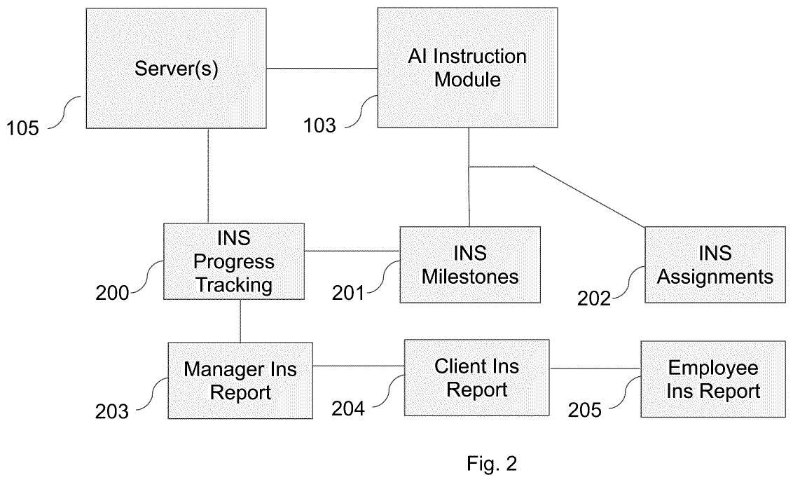

FIG. 2 illustrates one embodiment of the AI instruction module 103. The AI instruction module 103 determines a training status of the employee, and predicts an optimal training trajectory, comprised of a plurality of metrics, INS assignments 202, INS milestones 201, while INS progress tracking 200 tracks the progress of the employee 100 generating a manager INS report 203, a client INS report 204, and an employee INS report 205 based on the completion of an assigned optimal training trajectory.

In one embodiment of the current disclosure a reference will be made to an employee training for HIPPA compliance framework. The AI instruction module 103 determines a training status of an employee comparing a plurality of metrics of the employee to a scored database of employees of the same occupation, assigning a score to the training status of the employee from server(s) 105. The AI instruction module 103 predicts an optimal training trajectory of INS assignments 202 comprised of protocols from NIST framework for HIPPA compliance, establishes a time interval for training completion, and determines INS milestones 201 for employee 100 to complete the INS milestones 201 and INS assignments 202. At the expiration of the time interval, the AI instruction module 103 retrieves the INS assignments 202 and INS milestones 201 assigned to the employee 100, server(s) 105 and evaluates information about INS assignments 202, INS milestones 201, and INS progress tracking 200 determines by one or more processors a manager ins report 203, a client ins report 204, and an employee INS report 205 based on the completion of an assigned optimal training trajectory.

In one embodiment of the current disclosure the AI instruction module 103 is structured as a feedforward recurrent neural network model with back propagation that applies a cost function to an output layer. An input layer node size of the AI instruction module 103 would be determined by a plurality of employee metrics, e.g., educational background, relevant experience, a job function specific exam, and relevant certifications, but not limited to these, the metrics dependent on the occupation of the employee 100.

Middle layers of the AI instruction module 103 are formed of at least two layers. The size of the middle layers of the AI instruction module 103 are determined by the input layer size. A first middle layer of the AI instruction module 103 is equal to or larger than the input layer. A second layer of the AI instruction module 103 is equal to or larger than the first layer of the AI instruction module 103. The middle layers of the AI instruction module 103 form a weighted sum of the input layer the weighted sum forms an input to the output layer. Error correction of node weights and biases are determined by a cost function applied to all nodes in the middle layer.

In one embodiment of the current disclosure the AI instruction module 103 will retrieve information about the employee 100 from a server(s) 105. The information comprised of but not limited to a plurality of metrics, educational background, relevant experience, a job function specific exam, relevant certifications, a score for completion of any assignments completed within the software, an interval of time representing the time taken to complete an INS assignment 202 a INS milestone 201 or the like.

The AI instruction module 103, based on a target training status of the employee 100 will predict an optimal training trajectory comprised of INS assignments 202, INS milestones 201, and progress tracking 203 for the employee 100 and determine a time interval for completion of INS assignments 202, INS milestones 201 based on a target training status database of employees of similar occupation and similar plurality of metrics.

In one embodiment of the current disclosure the AI instruction module 103 predicts an optimal training trajectory INS assignments 202, INS milestones 201, and INS progress tracking 200 for an employee 100. The AI instruction module 103 retrieves employee 100 information from a server(s) 105. The information may be comprised of a plurality of metrics, aggregated with other data about the employee 100. Aggregated data comprising educational background, relevant experience, a job function specific exam, relevant certifications, and a score for organization specific assignments. The AI instruction module 103 trained on a database comprised of a similar plurality of metrics for a specific occupation would predict an optimal training trajectory for INS assignments 202, INS milestones 201, and INS progress tracking 200 that would allow the employee 100 to complete the required compliance framework for their occupation within the time intervals allotted for each INS assignment 202, and INS milestone 201.

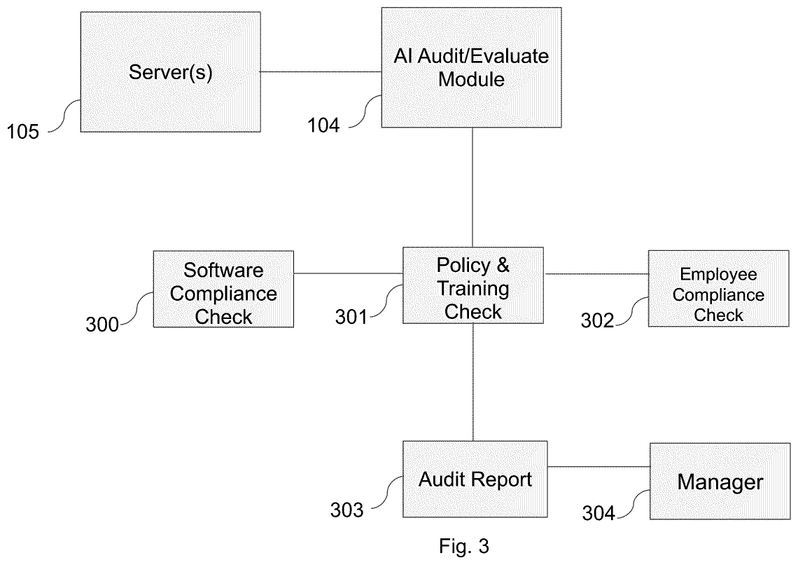

FIG. 3 illustrates one embodiment of the AI audit/evaluate module 104. The AI audit/evaluate module 104 retrieves aggregated data on policy and training, employee 100 compliance, and software compliance from server(s) 105 and predicts, based on data from similar data sets of compliance audit cycle data sets, software compliance check 300, policy and training check 301, employee compliance check 302 retrieved from server(s) 105 the outcome of a compliance audit cycle, generating an audit report 303.

In one embodiment of the current disclosure the AI audit/evaluate module 104 predicts, a software compliance check 300, based on a plurality of metrics of similar from server(s) 105 whether an organizations' software is compliant with NIST framework for HIPPA compliance. The AI audit/evaluate module 104 accomplishes this task by retrieving from server(s) 105 information about software on an organizations' machines and predicts based on training data from similar audit compliance cycles whether the organization will pass a software compliance check 300 audit.

In one embodiment of the current disclosure the AI audit/evaluate module 104 predicts, a policy and training check 301 prediction, based on a plurality of metrics of similar employees 100 from server(s) 105 whether an organizations' policy and training check 301 is compliant with NIST framework for HIPPA compliance. The AI audit/evaluate module 104 accomplishes this task by retrieving from server(s) 105 information about an organizations' policy and training data and predicts based on training data whether the organization will pass a policy and training check 301 audit.

In one embodiment of the current disclosure the AI audit/evaluate module 104 predicts, an employee compliance check 302 prediction, based on a plurality of metrics of similar employees 100 from server(s) 105 whether an organizations' employee training is compliant with NIST framework for HIPPA compliance. The AI audit/evaluate module 104 accomplishes this task by retrieving from server(s) 105 information about employees' 100 training and predicts based on training data whether the organizations' employee 100 will pass an employee 100 compliance check 302 audit.

In one embodiment of the current disclosure the AI audit/evaluate module 104 is structured as a feedforward recurrent neural network model with back propagation that applies a cost function to an output layer. An input layer node size of the AI audit evaluate module 104 would be determined by a plurality of metrics within the software compliance check 300, the policy and training check 301, and the employee compliance check 302, but not limited to these, the metrics dependent on the type and depth of the audit cycle.

Middle layers of the AI audit/evaluate module 104 are formed of at least two layers. The size of the middle layers of the AI audit/evaluate module 104 are determined by the input layer size. A first middle layer of the AI audit/evaluate module 104 is equal to or larger than the input layer. A second layer of the AI audit/evaluate module 104 is equal to or larger than the first layer of the AI audit/evaluate module 104. The middle layers of the AI audit/evaluate module 104 form a weighted sum of the input layer the weighted sum forms an input to the output layer. Error correction of node weights and biases are determined by a cost function applied to all nodes in the middle layer. The output layer predicting the outcome of an audit based on the metrics of the input software compliance check 300, policy and training check 301, and employee compliance check 302.

The AI audit/evaluate module 104 predicts based on a plurality of metrics software compliance check 300, policy and training check 301, and employee compliance check 302 the outcome of a compliance audit cycle as audit report 303.

In one embodiment of the current disclosure the AI audit/evaluate module 104 determines, based on a plurality of metrics of similar employees 302 from server(s) 105 INS assignments 202 comprised of a protocol from NIST framework for HIPPA compliance, and determines INS milestones 201 for employee 100 to complete. The AI audit/evaluate module 104 would then evaluate INS assignments 202 and INS milestones 201 assigned to the employee 100, server(s) 105 retrieve information about INS assignments 202 and INS milestones 201 from INS progress tracking 200 from server(s) 105, based on information, send an audit report 303 to a manager 304.

A method comprising: predicting by one or more processors based on aggregated data, and a plurality of metrics associated with an employee, the aggregated data including employee information, activities performed by the employee using a computing device, determining by one or more processors a training status of the employee, predicting by one or more artificial intelligence modules executed on one or more processors an optimal training trajectory of the employee; and sending by the one more processors assignments and milestones, and progress tracking associated with the optimal training trajectory to the employee, and to the employees' manager.

The method comprising: receiving, from a computing device data related to employee data, along with aggregated data, a time interval associated with a selection of activities of the employee from the optimal training trajectory.

The method comprising: determining by one or more processors a training status of the employee; comparing a plurality of metrics of the employee to a scored database of employees of the same occupation, assigning a score to the training status of the employee.

The method wherein the optimal training trajectory comprises: scheduling an assignment; scheduling a milestone; scheduling a meeting with a manager; determining a time interval for the completion of assignments or milestones; or any combination thereof.

The method further comprising: determining by one or more processors a training status of an employee, updating the score of an employees' training status, assigning a new time interval to complete a portion of the optimal training trajectory.

The method wherein progress tracking comprises: determining by one or more processors a manager report, a client report, and an employee report based on the completion of an assigned optimal training trajectory.

A server comprising: one or more processors; and one or more non-transitory computer readable media storing instructions executable by one or more processors to perform operations comprising: determining based on aggregated data, a plurality of metrics associated with an employee; determining a training status of an employee; predicting by one or more artificial intelligence modules executed on the server an optimal training trajectory and sending by the one more more processors assignments and milestones associated with the optimal training trajectory to the employee, and to the employees' manager.

The server, further comprising: receiving from a computing device, data associated with an employee, storing said data with aggregated data; and selecting a portion of the aggregated data to be associated with a time interval.

The server comprising: determining by one or more processors a training status of the employee; comparing a plurality of metrics of the employee to a scored database of employees of the same occupation, assigning a score to the training status of the employee.

The server wherein the optimal training trajectory comprises: scheduling an assignment; scheduling a milestone; scheduling a meeting with a manager; determining a time interval for the completion of assignments or milestones; or any combination thereof.

The server further comprising: determining by one or more processors a training status of an employee, updating the score of an employees' training status, assigning a new time interval to complete a portion of the optimal training trajectory.

The server wherein progress tracking comprises: determining by one or more processors a manager report, a client report, and an employee report based on the completion of an assigned optimal training trajectory.

A server comprising: one or more processors; and one or more non-transitory computer readable media storing instructions executable by one or more processors to perform operations comprising: determining a target compliance audit outcome, based on aggregated data, and data from employees activities a plurality of metrics associated with a compliance audit cycle and; predicting by one or more artificial intelligence modules executed on the server an optimal compliance audit cycle outcome, and generating a report.

The server of claim comprising: receiving, from a computing device, scored target compliance audit outcome data, the data related to a plurality of metrics associated with policy and training, software compliance, and employee compliance. The server comprising: determining by one or more processors, based on aggregated data, and data from employees activities, target compliance audit outcome, policy and training compliance audit training data.

The server comprising: determining by one or more processors, based on aggregated data, and data from employees activities, target compliance audit outcome, software compliance audit training data. The server comprising: determining by one or more processors, based on aggregated data, and data from employees activities, target compliance audit outcome, employee compliance audit training data. The server comprising: predicting by one or more artificial intelligence modules executed on the server an optimal policy and training compliance outcome, based on target policy and training compliance audit training data, and generating a report.

The server comprising: predicting by one or more artificial intelligence modules executed on the server an optimal software compliance audit outcome, based on target software compliance audit training data, and generating a report. The server comprising: predicting by one or more artificial intelligence modules executed on the server an optimal employee compliance audit outcome, based on target employee compliance audit training data, and generating a report.

1. A method comprising: predicting by one or more processors, based on aggregated data, and a plurality of metrics associated with an employee, the aggregated data including employee information, activities performed by the employee using a computing device, determining by one or more processors a training status of the employee, predicting by one or more artificial intelligence modules executed on one or more processors an optimal training trajectory of the employee; and sending by the one more processors assignments and milestones, and progress tracking associated with the optimal training trajectory to the employee, and to the employees' manager.

2. The method of claim 1 comprising: receiving, from a computing device data related to employee data, along with aggregated data, a time interval associated with a selection of activities of the employee from the optimal training trajectory.

3. The method of claim 1 comprising: determining, by one or more processors a training status of the employee; comparing a plurality of metrics of the employee to a scored database of employees of the same occupation, assigning a score to the training status of the employee.

4. The method of claim 1 wherein the optimal training trajectory comprises: scheduling an assignment; scheduling a milestone; scheduling a meeting with a manager; determining a time interval for the completion of assignments or milestones; or any combination thereof.

5. The method of claim 3 further comprising: determining, by one or more processors a training status of an employee, updating the score of an employees' training status, assigning a new time interval to complete a portion of the optimal training trajectory.

6. The method of claim 1 wherein progress tracking comprises: determining by one or more processors a manager report, a client report, and an employee report based on the completion of an assigned optimal training trajectory.

7. A server comprising: one or more processors; and one or more non-transitory computer readable media storing instructions executable by one or more processors to perform operations comprising: determining, based on aggregated data, a plurality of metrics associated with an employee; determining, a training status of an employee; predicting by one or more artificial intelligence modules executed on the server an optimal training trajectory, and sending by the one more processors assignments and milestones associated with the optimal training trajectory to the employee, and to the employees' manager.

8. The server of claim 7, further comprising: receiving from a computing device, data associated with an employee, storing said data with aggregated data; and selecting a portion of the aggregated data to be associated with a time interval.

9. The server of claim 7 comprising: determining, by one or more processors a training status of the employee; comparing a plurality of metrics of the employee to a scored database of employees of the same occupation, assigning a score to the training status of the employee.

10. The server of claim 7 wherein the optimal training trajectory comprises: scheduling an assignment; scheduling a milestone; scheduling a meeting with a manager; determining a time interval for the completion of assignments or milestones; or any combination thereof.

11. The server of claim 7 further comprising: determining, by one or more processors a training status of an employee, updating the score of an employees' training status, assigning a new time interval to complete a portion of the optimal training trajectory.

12. The server of claim 7 wherein progress tracking comprises: determining, by one or more processors a manager report, a client report, and an employee report based on the completion of an assigned optimal training trajectory.

13. A server comprising: one or more processors; and one or more non-transitory computer readable media storing instructions executable by one or more processors to perform operations comprising: determining a target compliance audit outcome, based on aggregated data, and data from employees activities a plurality of metrics associated with a compliance audit cycle and; predicting by one or more artificial intelligence modules executed on the server an optimal compliance audit cycle outcome, and generating a report.

14. The server of claim 13 comprising; receiving, from a computing device, scored target compliance audit outcome data, the data related to a plurality of metrics associated with policy and training, software compliance, and employee compliance.

15. The server of claim 13 comprising: determining, by one or more processors, based on aggregated data, and data from employees activities, target compliance audit outcome, policy and training compliance audit training data.

16. The server of claim 13 comprising: determining, by one or more processors, based on aggregated data, and data from employees activities, target compliance audit outcome, software compliance audit training data.

17. The server of claim 13 comprising: determining, by one or more processors, based on aggregated data, and data from employees activities, target compliance audit outcome, employee compliance audit training data.

18. The server of claim 13 comprising: predicting, by one or more artificial intelligence modules executed on the server an optimal policy and training compliance outcome, based on target policy and training compliance audit training data, and generating a report.

19. The server of claim 13 comprising: predicting, by one or more artificial intelligence modules executed on the server an optimal software compliance audit outcome, based on target software compliance audit training data, and generating a report.

20. The server of claim 13 comprising: predicting, by one or more artificial intelligence modules executed on the server an optimal employee compliance audit outcome, based on target employee compliance audit training data, and generating a report.
